(19) United States
(12) Patent Application Publication
(10) Pub. No.: US 2022/0113958 A1
(43) Pub. Date: Apr. 14, 2022

(54) FUNCTION EXTENSION SYSTEM AND ELECTRONIC CONTROL DEVICE

(71) Applicant: DENSO CORPORATION, Kariya-city (JP)

(72) Inventors: Ayaka OSAKABE, Kariya-city (JP); Kazutomo TSUCHIKAWA, Kariya-city (JP)

(21) Appl. No.: 17/558,303

(22) Filed: Dec. 21, 2021

Related U.S. Application Data
(63) Continuation of application No. PCT/JP2020/023717, filed on Jun. 17, 2020.

(30) Foreign Application Priority Data
Jun. 26, 2019 (JP) 2019-118579

(51) Int. Cl. G06F 8/65; H04L 67/125; H04L 67/00

(52) U.S. Cl. CPC G06F 8/65; H04L 67/34; H04L 67/125

(57) ABSTRACT

A function extension system includes a first electronic control device, a second electronic control device, and a server. The first electronic control device includes a user information transmission unit configured to transmit user information to the server. The second electronic control device includes a specification information transmission unit configured to transmit specification information indicative of a specification of the second electronic control device to the server and a download unit configured to, when receiving an application list including at least one piece of application specifying information for specifying an application available to the at least one second electronic control device, download an application program specified by the application specifying information from the server. The server includes a creation unit configured to create the application list based on the user information and the specification information when receiving the user information and the specification information.

### CROSS REFERENCE TO RELATED APPLICATION

This application is a continuation application of International Patent Application No. PCT/JP2020/023717 filed on Jun. 17, 2020, which designated the U.S. and claims the benefit of priority from Japanese Patent Application No. 2019-118579 filed on Jun. 26, 2019. The entire disclosure of all of the above application is incorporated herein by reference.

### TECHNICAL FIELD

This disclosure relates to a function extension system that extends a function of an electronic control device mounted on a vehicle.

### BACKGROUND

There has been a computer system incorporated in an automobile or the like. In a human-machine interface control unit that controls a display device installed in a cockpit of a vehicle, an operating system used in a mobile terminal (hereinafter, referred to as a mobile terminal OS) is rapidly becoming widespread. The mobile terminal OS is often updated every year, and the function installed in the mobile terminal OS is extended by the update. Therefore, functions of applications installed in the mobile terminal OS also increase. Accordingly, it is necessary to improve performance of hardware mounted in the mobile terminal.

### SUMMARY

According to one aspect of the present disclosure, a function extension system includes: a first electronic control device mounted in a vehicle; at least one second electronic control device mounted in the vehicle; and a server disposed outside of the vehicle and configured to perform data communication with both the first electronic control device and the at least one second electronic control device.

The first electronic control device includes: a first control unit configured to execute a first operating system for operating at least one first application that controls a device mounted in the vehicle; a first device communication unit configured to perform data communication with the at least one second electronic control device; a first server communication unit configured to perform data communication with the server; a housing configured to house the first control unit, the first device communication unit, and the first server communication unit therein; and a user information transmission unit configured to transmit user information for identifying a user of the vehicle to the server when the data communication with the second electronic control device is established by the first device communication unit.

The at least one second electronic control device includes: a second control unit configured to execute a second operating system for operating at least one second application that controls a device mounted in the vehicle; a second device communication unit configured to perform data communication with the first electronic control device; a second server communication unit configured to perform data communication with the server; a specification information transmission unit configured to transmit specification information indicative of a specification of the at least one second electronic control device to the server; and a download unit configured to, when receiving an application list including at least one piece of application specifying information for specifying an application available to the at least one second electronic control device, download an application program specified by the application specifying information from the server.

The server includes a creation unit configured to: create the application list based on the user information and the specification information when receiving the user information and the specification information; and transmit the created application list.

### BRIEF DESCRIPTION OF DRAWINGS

FIG. 1 is a block diagram showing a configuration of a function extension system.

FIG. 2 is a block diagram showing a configuration of an HCU and an extension module.

FIG. 3 is a functional block diagram showing a functional configuration of the HCU and the extension module according to a first embodiment.

FIG. 4 is a block diagram showing a configuration of a server.

FIG. 5 is a flowchart showing starting processing.

FIG. 6 is a flowchart showing a first half of function extension processing according to the first embodiment.

FIG. 7 is a flowchart showing a latter half of the function extension processing according to the first embodiment.

FIG. 8 is a table showing application information.

FIG. 9 is a flowchart showing instruction handling processing according to the first embodiment.

FIG. 10 is a flowchart showing list transmission processing.

FIG. 11 is a diagram showing a flow of data according to a first embodiment.

FIG. 12 is a flowchart showing a latter half of function extension processing according to a second embodiment.

FIG. 13 is a flowchart showing instruction handling processing according to the second embodiment.

FIG. 14 is a functional block diagram showing a functional configuration of an HCU and an extension module according to a third embodiment.

FIG. 15 is a diagram showing an HCU and an extension module according to a fourth embodiment.

FIG. 16 is a diagram showing an HCU and an extension module according to a fifth embodiment.

FIG. 17 is a functional block diagram showing a functional configuration of an HCU and an extension module according to a sixth embodiment.

FIG. 18 is a diagram showing a flow of data according to a seventh embodiment.

FIG. 19 is a diagram showing a flow of data according to an eighth embodiment.

FIG. 20 is a diagram showing a flow of data according to a ninth embodiment.

### DETAILED DESCRIPTION

To begin with, a relevant technology of the present disclosure will be described only for understanding the following embodiments.

According to detailed studies conducted by inventors of the present disclosure, there has been found a problem that in an electronic control device mounted on a vehicle, it is difficult to replace the hardware every year or every several years after shipment of the vehicle.

The present disclosure is to facilitate function extension of the electronic control device after shipment of the vehicle.

As described above, according to the one aspect of the present disclosure, a function extension system includes: a first electronic control device mounted in a vehicle; at least one second electronic control device mounted in the vehicle; and a server disposed outside of the vehicle and configured to perform data communication with both the first electronic control device and the at least one second electronic control device.

The first electronic control device includes: a first control unit configured to execute a first operating system for operating at least one first application that controls a device mounted in the vehicle; a first device communication unit configured to perform data communication with the at least one second electronic control device; a first server communication unit configured to perform data communication with the server; a housing configured to house the first control unit, the first device communication unit, and the first server communication unit therein; and a user information transmission unit configured to transmit user information for identifying a user of the vehicle to the server when the data communication with the second electronic control device is established by the first device communication unit.

The at least one second electronic control device includes: a second control unit configured to execute a second operating system for operating at least one second application that controls a device mounted in the vehicle; a second device communication unit configured to perform data communication with the first electronic control device; a second server communication unit configured to perform data communication with the server; a specification information transmission unit configured to transmit specification information indicative of a specification of the at least one second electronic control device to the server; and a download unit configured to, when receiving an application list including at least one piece of application specifying information for specifying an application available to the at least one second electronic control device, download an application program specified by the application specifying information from the server.

The server includes a creation unit configured to: create the application list based on the user information and the specification information when receiving the user information and the specification information; and transmit the created application list.

The function extension system according to the present disclosure configured as described above can control the device mounted on the vehicle by the first device communication unit and the second device communication unit performing data communication between the first electronic control device and the at least one second electronic control device. Since the first application operating on the first electronic control device and the second application operating on the at least one second electronic control device are different from each other, less data is used while being exchanged between the first application and the second application. Therefore, the function extension system according to the present disclosure can limit an increase in a data amount transmitted and received between the first electronic control device and the at least one second electronic control device. Accordingly, the function extension system according to the present disclosure can control the device mounted on the vehicle by connecting the first electronic control device and the at least one second electronic control device using communication having lower communication performance than communication using a communication bus inside the first control unit and the second control unit.

In the function extension system of the present disclosure, hardware of the at least one second electronic control device can be exchanged by replacing the at least one second electronic control device and connecting at least one new second electronic control device to the first electronic control device by communication. Therefore, in the function extension system of the present disclosure, by connecting at least one second electronic control device having higher performance than that before replacement to the first electronic control device, it is possible to improve the performance of the entire vehicle control system including the first electronic control device and the at least one second electronic control device.

In the function extension system according to the present disclosure, the at least one second electronic control device can be connected to the first electronic control device by communication between the first device communication unit and the second device communication unit. Accordingly, in the function extension system according to the present disclosure, there is no need to perform a replacement operation of connecting the first electronic control device and the at least one second electronic control device by opening a part of the housing of the first electronic control device and accommodating at least one new second electronic control device inside the housing of the first electronic control device. Therefore, in the function extension system according to the present disclosure, the first electronic control device and the at least one second electronic control device can be connected by a simple method of connecting the at least one second electronic control device to the first electronic control device by the communication between the first device communication unit and the second device communication unit.

In the function extension system according to the present disclosure, when an application list is received, the at least one second electronic control device downloads the application program specified by application specifying information from the server. Accordingly, the function extension system according to the present disclosure can acquire the application program, whose function is updated, from the server and use the application program in the at least one second electronic control device, and can improve the performance of the vehicle control system.

As described above, the function extension system according to the present disclosure can facilitate the function extension of the electronic control device after shipment of the vehicle.

According to another aspect of the present disclosure, an electronic control device is connected to an in-vehicle electronic control device mounted in a vehicle to perform data communication with the in-vehicle electronic control device. The electronic control device includes: a control unit configured to execute an operating system for operating at least one application that controls a device mounted in the vehicle; a device communication unit configured to perform data communication with the in-vehicle electronic control device; a server communication unit configured to perform data communication with a server disposed outside of the vehicle; a specification information transmission unit configured to transmit specification information indicative of a specification of the electronic control device to the server; and a download unit configured to, when receiving an application list including at least one piece of application specifying information for specifying an application available to the electronic control device, download an application program specified by the application specifying information from the server.

The electronic control device according to the present disclosure configured as described above is an electronic control device used in the function extension system according to the present disclosure, and the same effects as those of the function extension system according to the present disclosure can be obtained.

### First Embodiment

Hereinafter, a first embodiment according to the present disclosure will be described with reference to the drawings.

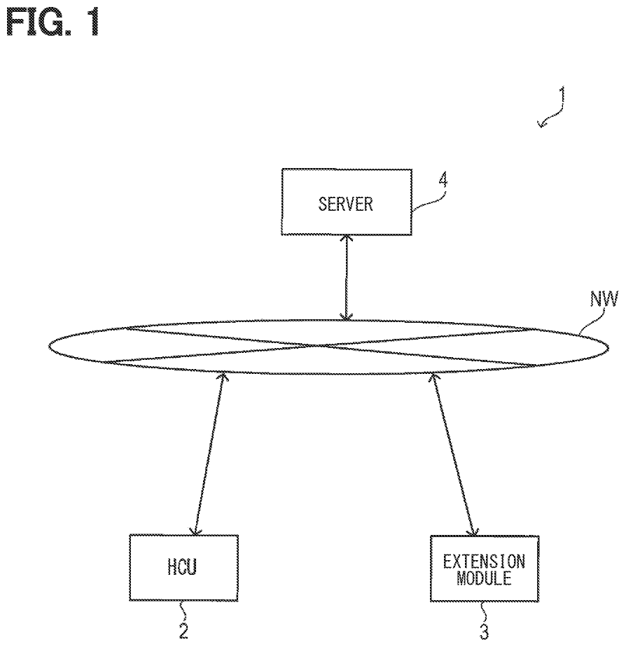

As shown in FIG. 1, a function extension system 1 according to the present embodiment includes a human-machine interface control unit 2 (hereinafter, HCU 2), an extension module 3, and a server 4. The HCU is an abbreviation for human machine interface control unit.

The HCU 2 is mounted on a vehicle and has a function of performing data communication with the server 4 via a wide area wireless communication network NW (for example, a cellular phone communication network).

The extension module 3 is mounted on the vehicle and has a function of performing data communication with the server 4 via the wide area wireless communication network NW. The extension module 3 may be installed at a position where the extension module 3 does not fall off during traveling of the vehicle, or may be provided with a locking mechanism so as not to fall off.

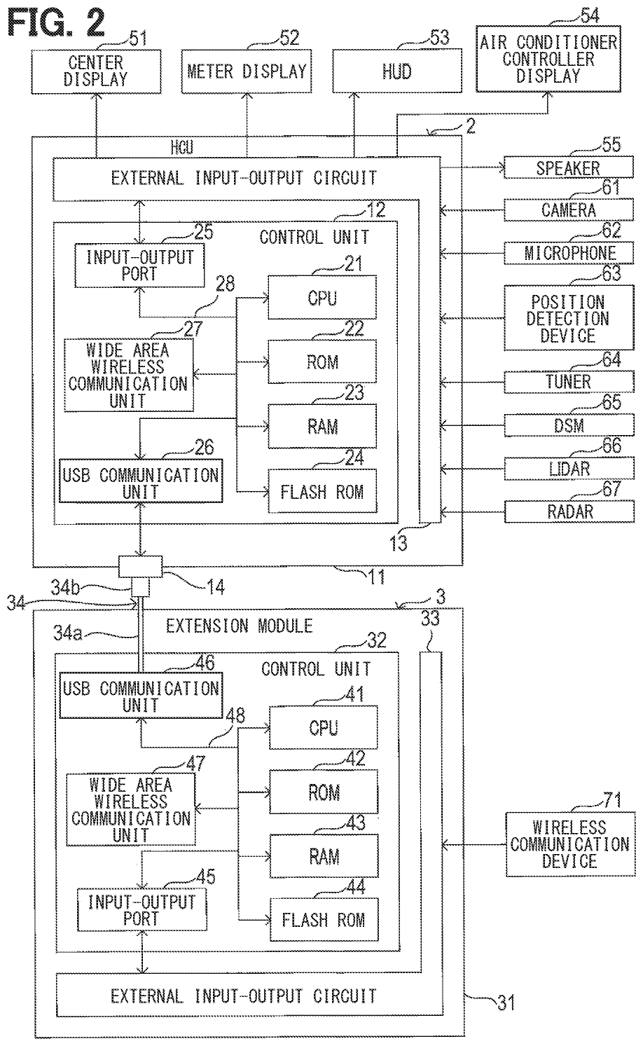

The HCU 2 is a semiconductor integrated circuit implemented by, for example, an SoC. As shown in FIG. 2, the HCU 2 includes a housing 11, a control unit 12, and an external input-output circuit 13 for performing signal input and output between the outside of the HCU 2 and the control unit 12. The SoC is an abbreviation for system on a chip.

The housing 11 is a metal member formed in a box shape, and accommodates the control unit 12 and the external input-output circuit 13 therein.

The control unit 12 includes a CPU 21, a ROM 22, a RAM 23, a flash ROM 24, an input-output port 25, a USB communication unit 26, a wide area wireless communication unit 27, and a bus line 28 that connects these units to one another. The USB is an abbreviation for universal serial bus.

The CPU 21 executes, based on programs stored in the ROM 22, various kinds of processing for controlling the HCU 2. The ROM 22 is a non-volatile memory, and stores programs to be executed by the CPU 21, and data to be referred to at the time of execution of the programs. The RAM 23 is a volatile memory, and temporarily stores a calculation result of the CPU 21.

The flash ROM 24 is a non-volatile memory whose stored contents are rewritable.

The input-output port 25 is a circuit for performing signal input and output between the outside of the control unit 12 and the control unit 12. The USB communication unit 26 transmits and receives data to and from a communication circuit, that is connected to the USB communication unit 26 via a USB connector 14 attached to an outer surface of the housing 11, in a form conforming to a USB standard. The wide area wireless communication unit 27 performs data communication with the server 4 via the wide area wireless communication network NW.

Various functions of the control unit 12 are implemented by the CPU 21 executing programs stored in a non-transitory tangible storage medium. In this example, the ROM 22 corresponds to the non-transitory tangible storage medium in which the programs are stored. A method corresponding to the program is executed by executing the program. A part or all of the functions to be executed by the CPU 21 may be configured in hardware by one or multiple ICs or the like.

The extension module 3 is, for example, a semiconductor integrated circuit implemented by a SoC, and includes a housing 31, a control unit 32, an external input-output circuit 33 for performing signal input and output between the outside of the extension module 3 and the control unit 32, and a USB cable 34.

The housing 31 is a metal member formed in a box shape, and accommodates the control unit 32 and the external input-output circuit 33 therein.

The control unit 32 includes a CPU 41, a ROM 42, a RAM 43, a flash ROM 44, an input-output port 45, a USB communication unit 46, a wide area wireless communication unit 47, and a bus line 48 that connects these units to one another.

The CPU 41 executes, based on programs stored in the ROM 42, various kinds of processing for controlling the extension module 3. The ROM 42 is a non-volatile memory, and stores programs to be executed by the CPU 41, and data to be referred to at the time of execution of the programs. The RAM 43 is a volatile memory, and temporarily stores a calculation result of the CPU 41.

The CPU 41 has higher processing performance than the CPU 21. That is, when the CPU 21 and the CPU 41 execute the same calculation processing, the CPU 41 can complete the calculation processing in a shorter time than the CPU 21.

The flash ROM 44 is a non-volatile memory whose stored contents are rewritable.

The input-output port 45 is a circuit for performing signal input and output between the outside of the control unit 32 and the control unit 32. The USB communication unit 46 transmits and receives data to and from the USB communication unit 26, that is connected to the USB communication unit 46 via the USB connector 14, in a form conforming to the USB standard. The wide area wireless communication unit 47 performs data communication with the server 4 via the wide area wireless communication network NW.

Various functions of the control unit 32 are implemented by the CPU 41 executing programs stored in a non-transitory tangible storage medium. In this example, the ROM 42 corresponds to the non-transitory tangible storage medium in which the programs are stored. A method corresponding to the program is executed by executing the program. A part or all of the functions to be executed by the CPU 41 may be configured in hardware by one or multiple ICs or the like.

The USB cable 34 includes a cable 34a and a USB connector 34b. One end of the cable 34a is connected to the USB communication unit 46, and the USB connector 34b is attached to the other end of the cable 34a. The USB connector 34b is formed so as to be attachable to and detachable from the USB connector 14. When the USB connector 34b is connected to the USB connector 14, USB communication is enabled between the USB communication unit 26 and the USB communication unit 46.

A center display 51, a meter display 52, a head-up display 53, an air conditioner controller display 54, and a speaker 55 are connected to the HCU 2.

The center display 51 is disposed in front of a portion between a driver's seat and a front passenger seat. The center display 51 is used as a display screen of various in-vehicle devices such as navigation and audio, and is also used as a display screen of an application. The meter display 52 is disposed in front of a steering and displays various meters and the like. The head-up display 53 displays various kinds of information on a windshield disposed in front of a driver. The air conditioner controller display 54 displays information (for example, a current set temperature) related to an air conditioner controller that controls an in-vehicle air conditioner. The speaker 55 is installed in a vehicle interior and outputs speech indicated by speech data received from the HCU 2.

A camera 61, a microphone 62, a position detection device 63, a tuner 64, a driver status monitor 65 (hereinafter, referred to as a DSM 65), a LIDAR 66, and a radar 67 are connected to the HCU 2. The DSM is an abbreviation for driver status monitor. The LIDAR is an abbreviation for light detection and ranging.

The camera 61 is attached to, for example, a rear side of the vehicle, and continuously images a situation behind the vehicle. The microphone 62 is installed in the vehicle interior, and inputs speech spoken by an occupant of the vehicle. The microphone 62 outputs speech data indicating the received speech.

The position detection device 63 includes a GPS receiver and a gyro sensor. The GPS is an abbreviation for global positioning system. The GPS receiver receives a GPS positioning signal transmitted from a GPS satellite and outputs the received GPS positioning signal. The gyro sensor detects an angular velocity of rotation about an X-axis, a Y-axis, and a Z-axis orthogonal to one another.

The tuner 64 receives radio broadcast signals of AM broadcast and FM broadcast. The DSM 65 detects a status of the driver by image analysis of a face image obtained by imaging a face of the driver. The LIDAR 66 detects a position of an object present around the vehicle by transmitting and receiving laser light. The radar 67 detects a position of an object present around the vehicle by transmitting and receiving radar waves in a millimeter wave band.

A wireless communication device 71 is connected to the extension module 3. The wireless communication device 71 includes a BT communication unit and a Wi-Fi communication unit. The BT communication unit performs short-range wireless communication in a form conforming to a Bluetooth standard. The Bluetooth is a registered trademark. The Wi-Fi communication unit performs short-range wireless communication in a form conforming to a Wi-Fi standard. The Wi-Fi is a registered trademark.

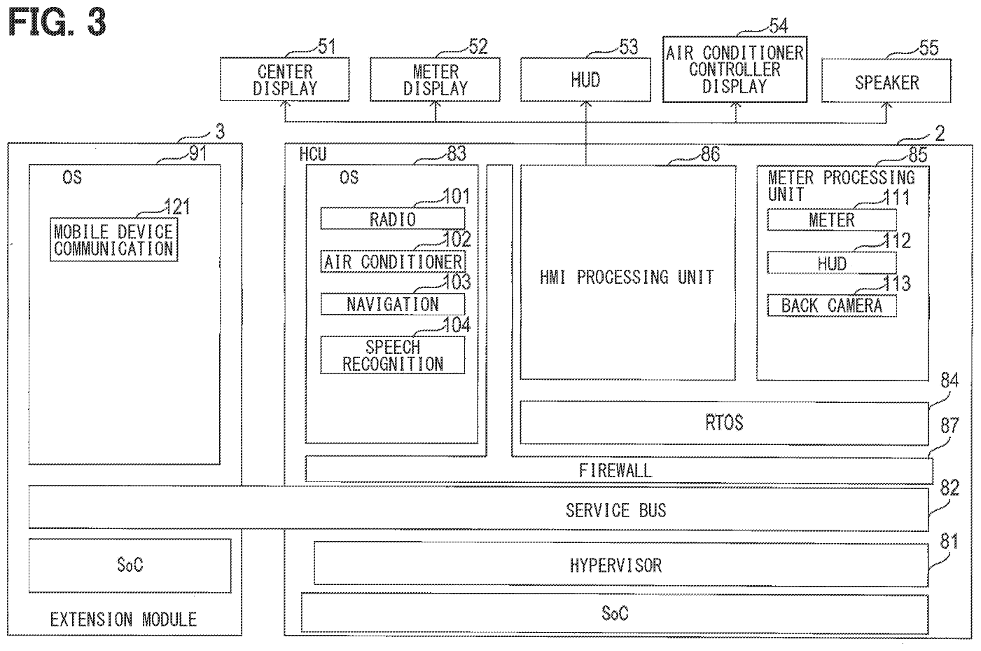

As shown in FIG. 3, the HCU 2 includes a hypervisor 81, a service bus 82, an operating system 83 (hereinafter, referred to as an OS 83), a real-time operating system 84 (hereinafter, referred to as a real-time OS 84), a meter processing unit 85, an HMI processing unit 86, and a firewall 87. The OS is an abbreviation for operating system. The HMI is an abbreviation for human machine interface.

The hypervisor 81 has a function of managing multiple operating systems in order to enable parallel execution of the multiple operating systems on the CPU 21. That is, the hypervisor 81 manages the OS 83 and the real-time OS 84.

The service bus 82 is an application that bridges data between an application layer and a lower layer representing any lower layer below a presentation layer. The service bus 82 transmits and receives data such that the HCU 2 and the extension module 3, which communicate with each other via the USB connector 14, can exchange data as if the HCU 2 and the extension module 3 are a single device. For this purpose, the service bus 82 includes a database for associating data used in the lower layer with data used in the application layer, and converts a format of the data between the application layer and the lower layer by referring to the database.

The OS 83 is basic software mounted in the HCU 2 in order to operate various applications. In the present embodiment, the OS 83 is an android. The android is a registered trademark.

In the present embodiment, the OS 83 operates a radio application 101, an air conditioner application 102, a navigation application 103, and a speech recognition application 104.

The radio application 101 executes processing for outputting speech based on the radio broadcast signal received by the tuner 64. The air conditioner application 102 controls an air conditioner mounted on the vehicle.

The navigation application 103 executes processing for displaying a current location of the vehicle, processing for guiding a path from the current location to a destination, and the like based on the position information detected by the position detection device 63.

The speech recognition application 104 executes processing for recognizing the speech detected by the microphone 62, processing for responding based on a recognition result, and the like.

The real-time OS 84 has a function of managing the HMI processing unit 86 and the meter processing unit 85 in order to enable parallel execution of the HMI processing unit 86 and the meter processing unit 85 on the CPU 21. The real-time OS 84 manages the HMI processing unit 86 and the meter processing unit 85 such that the processing real-time performance of the HMI processing unit 86 and the meter processing unit 85 can be ensured.

The meter processing unit 85 operates a meter application 111, a head-up display application 112, and a back camera application 113.

The meter application 111 executes processing for controlling display of the meter display 52. The head-up display application 112 executes processing for controlling display of the head-up display 53. The back camera application 113 executes processing for controlling display of an image captured by the camera 61.

The HMI processing unit 86 executes processing of controlling the display by the center display 51, the meter display 52, the head-up display 53, and the air conditioner controller display 54 based on the image data input from the outside of the HMI processing unit 86. The HMI processing unit 86 executes processing of controlling the speech output by the speaker 55 based on the speech data received from the outside of the HMI processing unit 86.

The firewall 87 restricts unauthorized access to the OS 83 from the outside of the OS 83. Further, the firewall 87 restricts the unauthorized access to the real-time OS 84 from the outside of the real-time OS 84.

The extension module 3 includes an operating system 91 (hereinafter, referred to as OS 91). The OS 91 is basic software mounted in the extension module 3 for operating various applications. In the present embodiment, the OS 91 is an android. The OS 91 operates a mobile device communication application 121.

The mobile device communication application 121 executes processing of transmitting and receiving data to and from the mobile device by the short-range wireless communication using the wireless communication device 71 and transmitting the received data to the HCU 2.

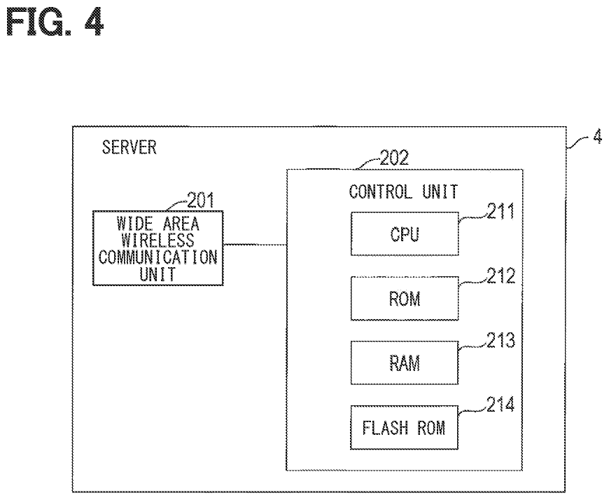

As shown in FIG. 4, the server 4 includes a wide area wireless communication unit 201 and a control unit 202. The wide area wireless communication unit 201 performs data communication with the HCU 2 and the extension module 3 via the wide area wireless communication network NW. The control unit 202 executes various kinds of processing based on an input from the wide area wireless communication unit 201, and controls the wide area wireless communication unit 201.

The control unit 202 is an electronic control device mainly implemented by a microcomputer including a CPU 211, a ROM 212, a RAM 213, a flash ROM 214, and the like. The flash ROM 214 is a non-volatile memory whose stored contents are rewritable.

Various functions of the microcomputer are implemented by the CPU 211 executing programs stored in a non-transitory tangible storage medium. In this example, the ROM 212 corresponds to the non-transitory tangible storage medium in which the programs are stored. A method corresponding to the program is executed by executing the program. A part or all of the functions to be executed by the CPU 211 may be configured in hardware by one or multiple ICs or the like. The number of microcomputers forming the control unit 202 may be one or more.

Next, a procedure of starting processing executed by the CPU 21 of the HCU 2 will be described. The starting processing is processing started when a power supply voltage is applied to the HCU 2. In a case where the extension module 3 is connected to the HCU 2 via the USB connector 14, when the power supply voltage is applied to the HCU 2, the power supply voltage is also applied to the extension module 3 via the USB connector 14. Accordingly, the CPU 41 of the extension module 3 is started, and the CPU 41 starts the OS 91.

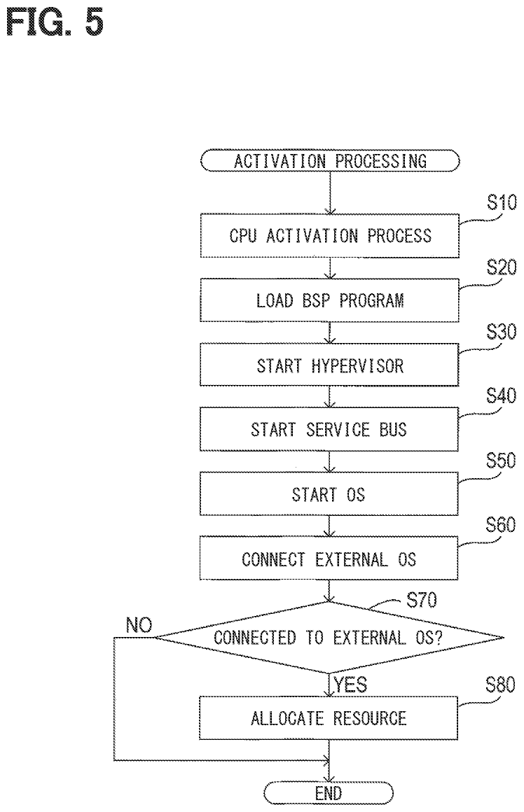

When the starting processing is executed, the CPU 21 of the HCU 2 first executes the startup processing to start the CPU 21 in S10, as shown in FIG. 5. Then, when the CPU 21 is started, the CPU 21 loads a BSP program in S20. The BSP is an abbreviation for board support package. The BSP program is a program necessary for executing the OS on the SoC implementing the HCU 2, and includes, for example, a program for executing hardware initialization processing.

Next, in S30, the CPU 21 starts the hypervisor 81. In S40, the CPU 21 starts the service bus 82. Thereafter, in S50, the CPU 21 starts the OS 83 and the real-time OS 84. In S60, the CPU 21 executes processing for connecting an external OS (that is, the OS 91) to the service bus 82.

In S70, the CPU 21 determines whether the service bus 82 is connected to the external OS (that is, the OS 91) of the HCU 2. Here, when the service bus 82 is not connected to the external OS, the CPU 21 ends the starting processing. On the other hand, when the service bus 82 is connected to the external OS, the CPU 21 allocates resources to the external OS in S80, and ends the starting processing. Specifically, the CPU 21 sets, in the RAM 23, a storage area for temporarily storing data received from the extension module 3.

Next, a procedure of function extension processing executed by the CPU 41 of the extension module 3 will be described. The function extension processing is started after the extension module 3 is connected to the HCU 2 and the OS 91 is started.

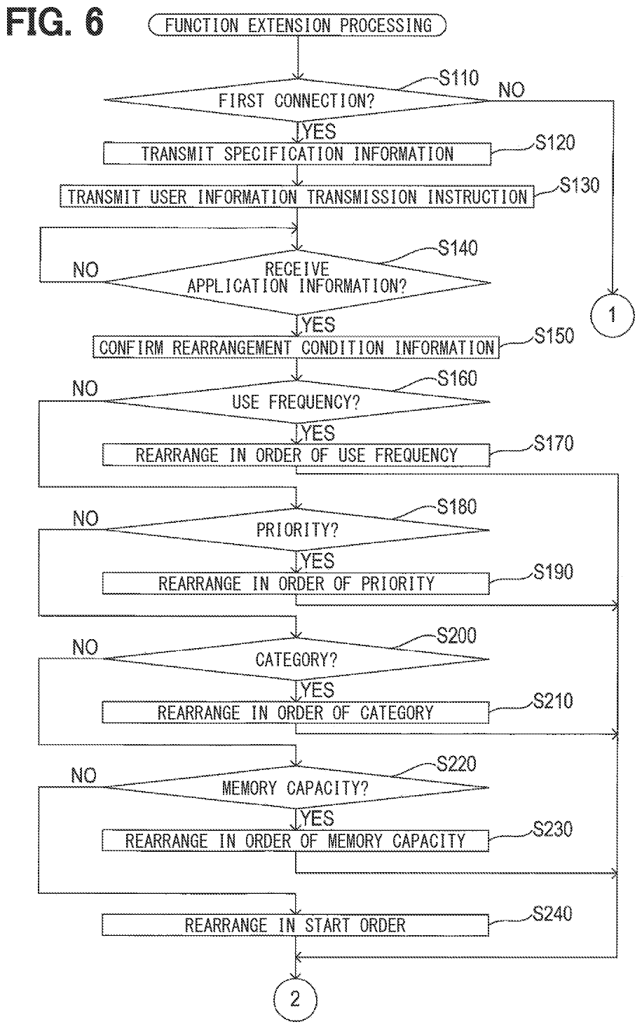

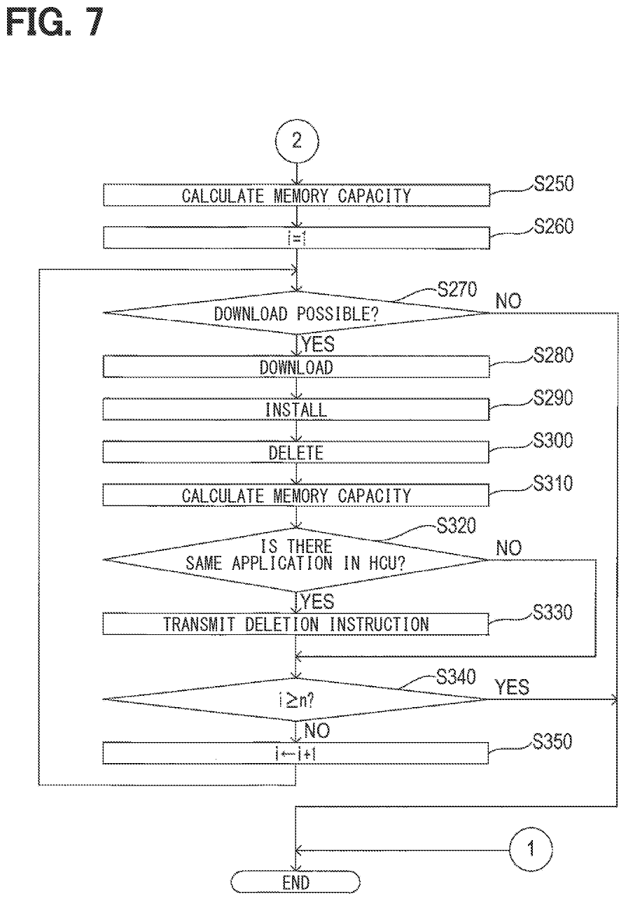

When the function extension processing is executed, as shown in FIGS. 6 and 7, the CPU 41 first determines whether the extension module 3 is connected to the HCU 2 for the first time in S110. When the number of times the extension module 3 is connected to the HCU 2 is two or more, the CPU 41 ends the function extension processing.

On the other hand, when the extension module 3 is connected to the HCU 2 for the first time, the CPU 41 transmits the specification information of the extension module 3 to the server 4 in S120. The specification information includes information related to the OS, the memory, and the like mounted in the extension module 3 (for example, types of the OS and memory capacity).

In S130, the CPU 41 transmits, to the HCU 2, a user information transmission instruction to transmit user information.

In S140, the CPU 41 determines whether application information API (hereinafter, referred to as application information API) is received from the HCU 2.

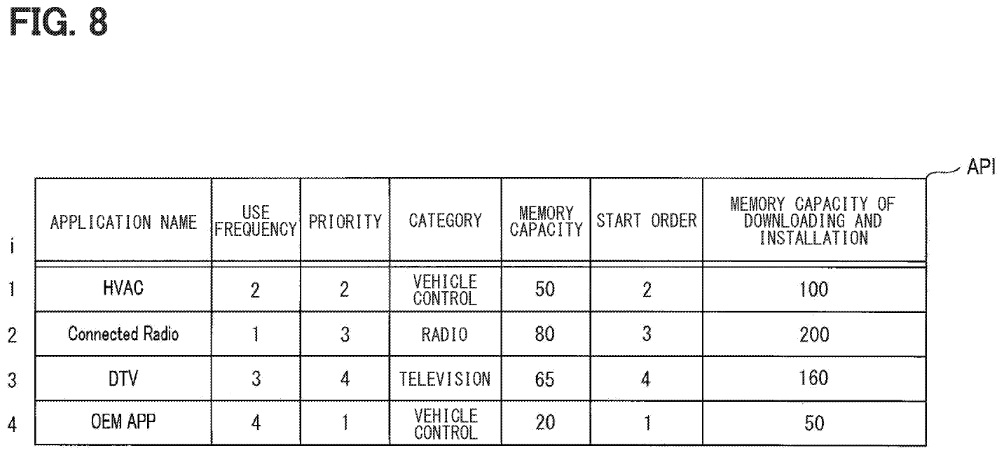

As shown in FIG. 8, the application information API includes information related to first, second, third, fourth, fifth, sixth, and seventh items for each of one or multiple function extension application programs (hereinafter, referred to as function extension application programs).

A first item is an application name (hereinafter, referred to as an application name). A second item is a use frequency. A third item is a priority. A fourth item is a category. In the category, “vehicle control”, “radio”, “television”, and the like are set.

A fifth item is a memory capacity for storing an application program. A sixth item is a start order. A seventh item is a memory capacity used for downloading and installation.

The application information API includes an item group in which the first, the second, the third, the fourth, the fifth, the sixth, and the seventh items are arranged in a lateral direction for each of one or more function extension application programs. That is, the application information API includes n item groups corresponding to n function extension application programs. N is an integer of 1 or more.

The application information API is formed by arranging n item groups along a longitudinal direction. Hereinafter, among the n item groups arranged along the longitudinal direction, an item group arranged at an i-th position from the top is referred to as an i-th item group. I is an integer from 1 to n. For example, in FIG. 8, an item group whose application name is “HVAC” is a first item group, and an item group whose application name is “Connected Radio” is a second item group.

In S140, when the application information API is not received, as shown in FIG. 6, the CPU 41 waits until the application information API is received by repeating the processing of S140. When the application information API is received, the CPU 41 confirms rearrangement condition information in S150. The rearrangement condition information is stored in the flash ROM 44. Any one of the “use frequency”, the “priority”, the “category”, the “memory capacity”, and the “start order” is set in advance by a manufacturer of the extension module 3.

Then, in S160, the CPU 41 determines whether the “use frequency” is set in the rearrangement condition information. When the “use frequency” is set, the CPU 41 rearranges the item groups of the application information API in descending order of the use frequency in S170, and moves the processing to S250. For example, in the application information API shown in FIG. 8, the CPU 41 rearranges the application information API such that the item group whose application name is “Connected Radio” is the first item group, the item group whose application name is “HVAC” is the second item group, the item group whose application name is “DTV” is the third item group, and the item group whose application name is “OEM APP” is the fourth item group.

On the other hand, when the “use frequency” is not set, the CPU 41 determines whether the “priority” is set in the rearrangement condition information in S180. When the “priority” is set, the CPU 41 rearranges the item groups of the application information API in descending order of priority in S190, and moves the processing to S250. For example, in the application information API shown in FIG. 8, the CPU 41 rearranges the application information API such that the item group whose application name is “OEM APP” is the first item group, the item group whose application name is “HVAC” is the second item group, the item group whose application name is “Connected Radio” is the third item group, and the item group whose application name is “DTV” is the fourth item group.

On the other hand, when the “priority” is not set, the CPU 41 determines whether the “category” is set in the rearrangement condition information in S200. When the “category” is set, the CPU 41 rearranges the item groups of the application information API for each category in S210, and moves the processing to S250. For example, in the application information API shown in FIG. 8, the CPU 41 rearranges the application information API such that the item group whose application name is “HVAC” is the first item group, the item group whose application name is “OEM APP” is the second item group, the item group whose application name is “Connected Radio” is the third item group, and the item group whose application name is “DTV” is the fourth item group.

On the other hand, when the “category” is not set, the CPU 41 determines whether the “memory capacity” is set in the rearrangement condition information in S220. When the “memory capacity” is set, the CPU 41 rearranges the item groups of the application information API in ascending order of the memory capacity in S230, and moves the processing to S250. For example, in the application information API shown in FIG. 8, the CPU 41 rearranges the application information API such that the item group whose application name is “OEM APP” is the first item group, the item group whose application name is “HVAC” is the second item group, the item group whose application name is “DTV” is the third item group, and the item group whose application name is “Connected Radio” is the fourth item group.

When the “memory capacity” is not set, the CPU 41 determines that the “start order” is set in the rearrangement condition information, rearranges the item groups of the application information API in the start order in S240, and moves the processing to S250. For example, in the application information API shown in FIG. 8, the CPU 41 rearranges the application information API such that the item group whose application name is “OEM APP” is the first item group, the item group whose application name is “HVAC” is the second item group, the item group whose application name is “DTV” is the third item group, and the item group whose application name is “Connected Radio” is the fourth item group.

In S250, the CPU 41 calculates an available memory capacity in the extension module 3.

In S260, the CPU 41 sets an item group indication value i provided in the RAM 43 to 1.

In S270, the CPU 41 determines whether the function extension application program corresponding to the i-th item group of the rearranged application information API can be downloaded. Specifically, the CPU 41 determines whether a value of the seventh item in the i-th item group of the rearranged application information API (that is, the memory capacity used for downloading and installation) exceeds an “available memory capacity” calculated in S250 or S310 to be described later.

Here, when the memory capacity used for downloading and installation exceeds the “available memory capacity”, the CPU 41 ends the function extension processing.

On the other hand, when the memory capacity used for downloading and installation is equal to or less than the “available memory capacity”, the CPU 41 downloads the function extension application program corresponding to the i-th item group of the application information API from the server 4 in S280. In S290, the CPU 41 installs the function extension application program downloaded in S280 in the OS 91. In S300, the CPU 41 deletes the function extension application program downloaded in S280 from the extension module 3. In S310, the CPU 41 calculates an available memory capacity in the extension module 3.

Next, in S320, the CPU 41 determines whether a function extension application program to which the same application name as the function extension application program downloaded in S280 is set is stored in the HCU 2.

Here, when the function extension application program to which the same application name is set is not stored in the HCU 2, the CPU 41 moves the processing to S340. On the other hand, when the function extension application program to which the same application name is set is stored in the HCU 2, the CPU 41 transmits, to the HCU 2, a deletion instruction instructing deletion of the function extension application program to which the same application name as the function extension application program downloaded in S280 is set in S330, and moves the processing to S340. When the HCU 2 receives the deletion instruction, the HCU 2 deletes the function extension application program specified by the deletion instruction.

In S340, the CPU 41 determines whether the item group indication value i is equal to or greater than a program number n. Here, when the item group indication value i is less than the program number n, the CPU 41 increments the item group indication value i (that is, adds 1) in S350, and moves the processing to S270.

On the other hand, when the item group indication value i is equal to or greater than the program number n, the CPU 41 ends the function extension processing.

Next, a procedure of instruction handling processing executed by the CPU 21 of the HCU 2 will be described. The instruction handling processing is processing repeatedly executed after the OS 83 is started.

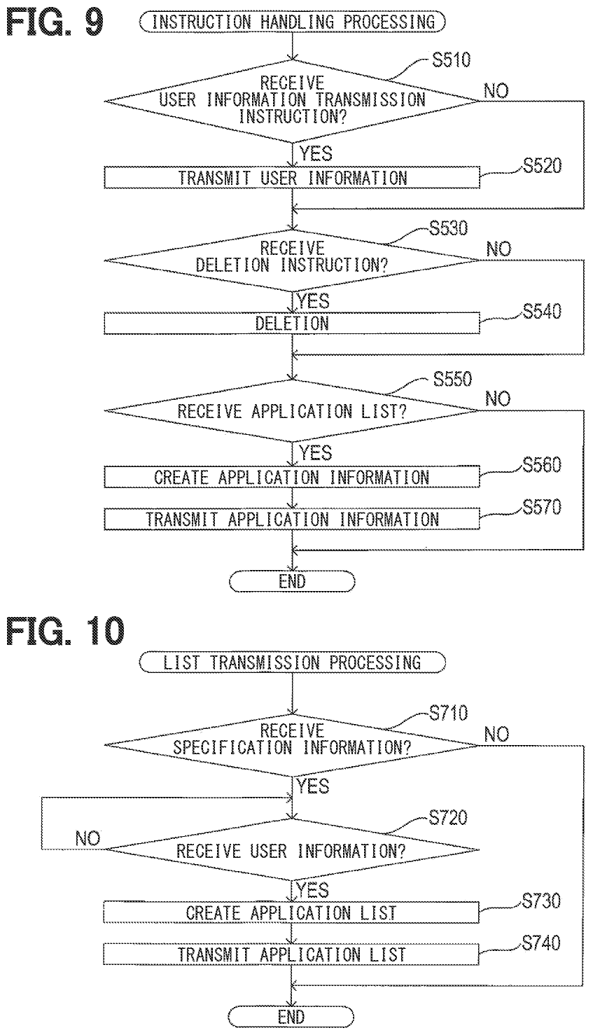

When the instruction handling processing is executed, as shown in FIG. 9, the CPU 21 first determines in S510 whether a user information transmission instruction is received from the extension module 3. Here, when the user information transmission instruction is not received, the CPU 21 moves the processing to S530. On the other hand, when the user information transmission instruction is received, the CPU 21 transmits the user information to the server 4 in S520, and moves the processing to S530. The user information is information (for example, a user ID) for identifying a user who uses a vehicle on which the HCU 2 is mounted.

In S530, the CPU 21 determines whether a deletion instruction is received from the extension module 3. Here, when the deletion instruction is not received, the CPU 21 moves the processing to S550. On the other hand, when the deletion instruction is received, the CPU 21 deletes the function extension application program specified by the deletion instruction in S540, and moves the processing to S550.

In S550, the CPU 21 determines whether an application list (hereinafter, referred to as an application list) is received from the server 4. The application list includes information indicating an application name of one or multiple function extension application programs that can be downloaded by the extension module 3, fifth item-related information corresponding to the application name, and seventh item-related information corresponding to the application name. The fifth item is a memory capacity for storing the application program. The seventh item is a memory capacity used for downloading and installation.

Here, when the application list is not received, the CPU 21 ends the instruction handling processing. On the other hand, when the application list is received, the CPU 21 creates the application information API in S560. Specifically, the CPU 21 creates the application information API by adding information related to the second, third, fourth, and sixth items to each of the one or multiple application names forming the application list. For example, the CPU 21 records the number of times the function extension application program is started for each of the multiple function extension application programs, and determines the use frequency based on the recorded number of times the function extension application program is started. The priority is determined by the OEM and the like, and is set in advance for each of the multiple application names. The CPU 21 determines the priority of the application information API based on the priority set in advance. The OEM is an abbreviation for original equipment manufacturer, and is a finished vehicle manufacturer. The category is determined by an application manufacturer or the OEM, and is set in advance for each of the multiple application names. The start sequence is set in advance for each of the multiple application names. The CPU 21 determines the start order based on the start sequence.

In S570, the CPU 21 transmits the application information API created in S560 to the extension module 3, and ends the instruction handling processing.

Next, a procedure of list transmission processing executed by the CPU 211 of the server 4 will be described. The list transmission processing is processing repeatedly executed during the operation of the control unit 202.

When the list transmission processing is executed, as shown in FIG. 10, the CPU 211 first determines in S710 whether specification information is received from the extension module 3. Here, when the specification information is not received, the CPU 211 ends the list transmission processing. On the other hand, when the specification information is received, the CPU 211 determines in S720 whether the user information is received from the HCU 2. Here, when the user information is not received, the CPU 211 waits until the user information is received by repeating the processing of S720. When the user information is received, the CPU 211 creates an application list in S730. Specifically, the CPU 211 selects, from among the multiple function extension application programs stored in the flash ROM 214, a function extension application program that is associated with the user information received in S720 and that is available in the specifications (that is, the OS and the memory capacity) specified by the specification information received in S710. The CPU 211 creates an application list by adding the above information of the first, fifth, and seventh items to each of the selected one or more function extension application programs. The first item is an application name. The fifth item is a memory capacity for storing the application program. The seventh item is a memory capacity used for downloading and installation.

In S740, the CPU 211 transmits the application list created in S730 to the HCU 2, and ends the list transmission processing.

Next, the control of the center display 51, the meter display 52, the head-up display 53, the air conditioner controller display 54, and the speaker 55 performed by the HCU 2 will be described.

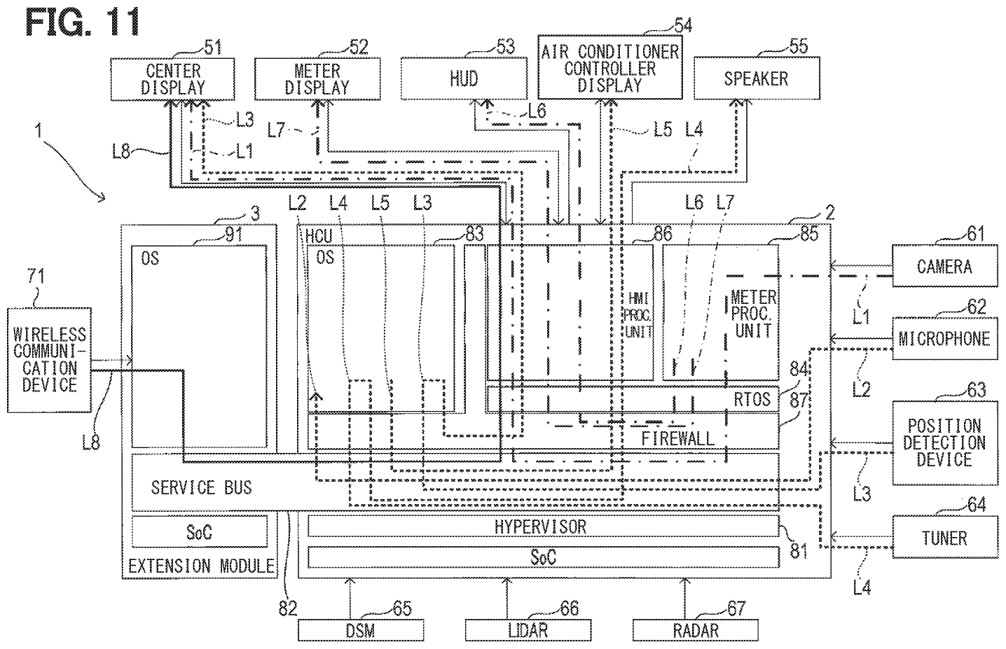

As shown in FIG. 11, data acquired by imaging of the camera 61 is input to the meter processing unit 85. The back camera application 113 mounted in the meter processing unit 85 uses the received data to create display data to be displayed on the center display 51. The back camera application 113 outputs the created display data to the HMI processing unit 86 via the service bus 82. The HMI processing unit 86 outputs the display data received from the meter processing unit 85 to the center display 51. A polygonal line L1 indicated by an alternate long and short dash line indicates a path of data from the camera 61 to the center display 51.

Data indicating the speech detected by the microphone 62 is input to the OS 83. The speech recognition application 104 mounted in the OS 83 performs speech recognition processing based on the received speech data, determines output speech to be output from the speaker 55 by performing necessary processing, and outputs data indicating the determined output speech to the HMI processing unit 86 via the service bus 82. The HMI processing unit 86 outputs the data received from the OS 83 to the speaker 55. A polygonal line L2 shown by a dashed line indicates a path of data from the microphone 62 to the OS 83.

Data indicating the position and detected by the position detection device 63 is input to the OS 83. The navigation application 103 mounted in the OS 83 creates, based on the received position data, display data to be displayed on the center display 51. The navigation application 103 outputs the created display data to the HMI processing unit 86 via the service bus 82. The HMI processing unit 86 outputs the display data received from the OS 83 to the center display 51. A polygonal line L3 shown by a dashed line indicates a path of data from the position detection device 63 to the center display 51.

Data indicating the radio broadcast signal and received by the tuner 64 is input to the OS 83. The radio application 101 mounted in the OS 83 creates, based on the received data, data indicating an output speech to be output from the speaker 55, and outputs the created data to the HMI processing unit 86 via the service bus 82. The HMI processing unit 86 outputs the data received from the OS 83 to the speaker 55. A polygonal line L4 shown by a dashed line indicates a path of data from the tuner 64 to the speaker 55.

The air conditioner application 102 mounted in the OS 83 creates display data to be displayed on the center display 51. The air conditioner application 102 outputs the created display data to the HMI processing unit 86 via the service bus 82. The HMI processing unit 86 outputs the display data received from the OS 83 to the air conditioner controller display 54. A polygonal line L5 shown by a dashed line indicates a path of data from the OS 83 to the air conditioner controller display 54.

The head-up display application 112 mounted in the meter processing unit 85 creates display data to be displayed on the head-up display 53. The head-up display application 112 outputs the created display data to the HMI processing unit 86 via the service bus 82. The HMI processing unit 86 outputs the display data received from the meter processing unit 85 to the head-up display 53. A polygonal line L6 indicated by an alternate long and short dash line indicates a path of data from the meter processing unit 85 to the head-up display 53.

The meter application 111 mounted in the meter processing unit 85 creates display data to be displayed on the meter display 52. The meter application 111 outputs the created display data to the HMI processing unit 86 via the service bus 82. The HMI processing unit 86 outputs the display data received from the meter processing unit 85 to the meter display 52. A polygonal line L7 indicated by an alternate long and short dash line indicates a path of data from the meter processing unit 85 to the meter display 52.

The data received by the wireless communication device 71 is input to the OS 91. The mobile device communication application 121 mounted in the OS 91 creates display data to be displayed on the center display 51. The mobile device communication application 121 outputs the created display data to the HMI processing unit 86 via the service bus 82. The HMI processing unit 86 outputs the display data received from the OS 91 to the center display 51. A polygonal line L8 shown by a solid line indicates a path of data from the wireless communication device 71 to the center display 51.

The function extension system 1 as described above includes the HCU 2 mounted in the vehicle, the extension module 3 mounted in the vehicle, and the server 4. The server 4 is disposed outside of the vehicle, and performs data communication with the HCU 2 and the extension module 3.

The HCU 2 includes the control unit 12, the USB communication unit 26, the wide area wireless communication unit 27, and the housing 11.

The control unit 12 executes the OS 83 for operating the radio application 101, the air conditioner application 102, the navigation application 103, and the speech recognition application 104. The radio application 101 controls the speaker 55 mounted on the vehicle. The air conditioner application 102 controls the air conditioner controller display 54 mounted on the vehicle. The navigation application 103 controls the center display 51 mounted on the vehicle. The speech recognition application 104 controls the speaker 55 mounted on the vehicle.

The USB communication unit 26 performs data communication with the extension module 3. The wide area wireless communication unit 27 performs data communication with the server 4. The housing 11 houses therein the control unit 12, the USB communication unit 26, and the wide area wireless communication unit 27.

When the control unit 12 is connected to the extension module 3 through the data communication performed by the USB communication unit 26, the control unit 12 transmits, to the server 4, the user information for identifying the user of the vehicle.

The extension module 3 includes the control unit 32, the USB communication unit 46, and the wide area wireless communication unit 47. The control unit 32 executes the OS 91 for operating the mobile device communication application 121 that controls the center display 51 mounted on the vehicle.

The USB communication unit 46 performs data communication with the HCU 2. The wide area wireless communication unit 47 performs data communication with the server 4.

The control unit 32 transmits the specification information indicating the specification of the extension module 3 to the server 4. When the control unit 32 receives the application information API from the HCU 2, the control unit 32 downloads the function extension application program specified by the application name from the server 4. The application information API includes information related to the first item (that is, the application name) for specifying the application available in the extension module 3.

The server 4 includes the control unit 202. When receiving the user information and the specification information, the control unit 202 creates the application list based on the user information and the specification information, and transmits the created application list to the HCU 2.

When the control unit 12 of the HCU 2 receives the application list from the server 4, the control unit 12 adds information related to the second, third, fourth, and sixth items for determining a download order of the function extension application program to the information related to the first item for each of the at least one application, and transmits the application list, to which the information related to the second, third, fourth, and sixth items is added, to the extension module 3 as the application information API.

The control unit 32 of the extension module 3 determines the download order of the function extension application programs based on the information related to the second, third, fourth, fifth, and sixth items added to the application information API transmitted from the HCU 2, and downloads the function extension application programs.

As described above, the function extension system 1 can control the devices mounted on the vehicle by the USB communication unit 26 and the USB communication unit 46 performing data communication between the HCU 2 and the extension module 3. Since the application operating on the HCU 2 (hereinafter, referred to as a first application) and the application operating on the extension module 3 (hereinafter, referred to as a second application) are different from each other, less data is used while being exchanged between the first application and the second application. Therefore, the function extension system 1 can limit an increase in a data amount transmitted and received between the HCU 2 and the extension module 3. Accordingly, the function extension system 1 can control the devices mounted on the vehicle by connecting the HCU 2 and the extension module 3 using communication having lower communication performance than communication performed using the bus lines 28 and 48 inside the control units 12 and 32.

In the function extension system 1, the hardware of the extension module 3 can be replaced by replacing the extension module 3 and connecting a new extension module 3 to the HCU 2. Therefore, the function extension system 1 can improve the performance of the entire vehicle control system including the HCU 2 and the extension module 3 by connecting the extension module 3 having higher performance than that before the replacement to the HCU 2.

Further, in the function extension system 1, the extension module 3 can be connected to the HCU 2 by communication between the USB communication unit 26 and the USB communication unit 46. Accordingly, in the function extension system 1, there is no need to perform a replacement operation of connecting the HCU 2 and the extension module 3 by opening a part of the housing 11 of the HCU 2 and accommodating the new extension module 3 inside the housing 11 of the HCU 2. Therefore, the function extension system 1 can connect the HCU 2 and the extension module 3 by a simple method of connecting the extension module 3 to the HCU 2 through communication between the USB communication unit 26 and the USB communication unit 46.

In the function extension system 1, when the extension module 3 receives the application information API, the extension module 3 downloads, from the server 4, the function extension application program specified by the information related to the first item. Accordingly, the function extension system 1 can acquire, from the server 4, the function extension application program in which the function is updated and use the function extension application program in the extension module 3, and can improve the performance of the vehicle control system.

As described above, the function extension system 1 can facilitate the function extension of the HCU 2 and the extension module 3 after the shipment of the vehicle.

In the application list, information related to second to sixth items for determining the download order of the application program is added to the information related to the first item for each of the at least one application. The function extension system 1 can determine the download order based on the information related to the second to sixth items added to the application information API, and download the function extension application program. Accordingly, when the multiple function extension application programs to be downloaded are different from each other in an importance degree, the function extension system 1 can prevent occurrence of a situation in which a function extension application program having a low importance degree is downloaded and a function extension application program having a high importance degree is not downloaded due to shortage of the storage capacity of the extension module 3.

The application information API includes information related to the use frequency of the application corresponding to the application name. Accordingly, the function extension system 1 can prevent occurrence of a situation in which a function extension application program having a low use frequency is downloaded and a function extension application program having a high use frequency is not downloaded due to the shortage of the storage capacity of the extension module 3.

The application information API includes information related to the priority of the application corresponding to the application name. Accordingly, the function extension system 1 can limit occurrence of a situation in which a function extension application program having a low priority is downloaded and a function extension application program having a high priority is not downloaded due to the shortage of the storage capacity of the extension module 3.

The application information API includes information related to the category of the application corresponding to the application name. Accordingly, the function extension system 1 can prevent occurrence of a situation in which a function extension application program of a category having a low importance degree is downloaded and a function extension application program of a category having a high importance degree is not downloaded.

The application information API includes information related to the memory capacity of the application corresponding to the application name. Therefore, the function extension system 1 can download the function extension application programs in the ascending order of the memory capacity. Accordingly, the function extension system 1 can prevent occurrence of a situation in which the number of function extension application programs to be downloaded is reduced due to the shortage of the storage capacity of the extension module 3.

The application information API includes information related to the start order of the application corresponding to the application name. Therefore, the function extension system 1 can download the function extension application programs in the ascending order of the start order. Accordingly, the function extension system 1 can download the function extension application program having an earlier start order preferentially and start the function extension application program at an early stage.

When the control unit 12 of the HCU 2 stores a corresponding application program corresponding to the function extension application program downloaded by the extension module 3, the control unit 12 deletes the corresponding application program. Accordingly, the function extension system 1 can increase the storage capacity of the HCU 2, reduce the load on the HCU 2 itself, and facilitate the operation of the application in the HCU 2.

Not only an updated application but also an application newly added to the extension module 3 can be downloaded by setting the application in the application information API.

In the embodiment described above, the HCU 2 corresponds to a first electronic control device and an in-vehicle electronic control device, and the extension module 3 corresponds to at least one second electronic control device and at least one electronic control device.

The control unit 12 corresponds to a first control unit. The USB communication unit 26 corresponds to a first device communication unit. The wide area wireless communication unit 27 corresponds to a first server communication unit. S520 corresponds to processing of the user information transmission unit.

The radio application 101, the air conditioner application 102, the navigation application 103, and the speech recognition application 104 correspond to a first application. The OS 83 corresponds to a first operating system.

The control unit 32 corresponds to a second control unit and a control unit. The USB communication unit 46 corresponds to a second device communication unit and a device communication unit. The wide area wireless communication unit 47 corresponds to a second server communication unit and a server communication unit. S120 corresponds to processing of the specification information transmission unit. S260 to S350 correspond to processing of a download unit.

The mobile device communication application 121 corresponds to the second application and the application. The OS 91 corresponds to a second operating system and an operating system.

S710 to S740 correspond to processing of a creation unit. The application name corresponds to the application specifying information. The information related to the second, third, fourth, fifth, and sixth items corresponds to determination information.

S540 corresponds to processing of a deletion unit.

### Second Embodiment

Hereinafter, a second embodiment according to the present disclosure will be described with reference to the drawings. In the second embodiment, portions different from those of the first embodiment will be described. The same components are denoted by the same reference numerals.

The function extension system 1 according to the second embodiment is different from that of the first embodiment in that function extension processing and instruction handling processing are changed.

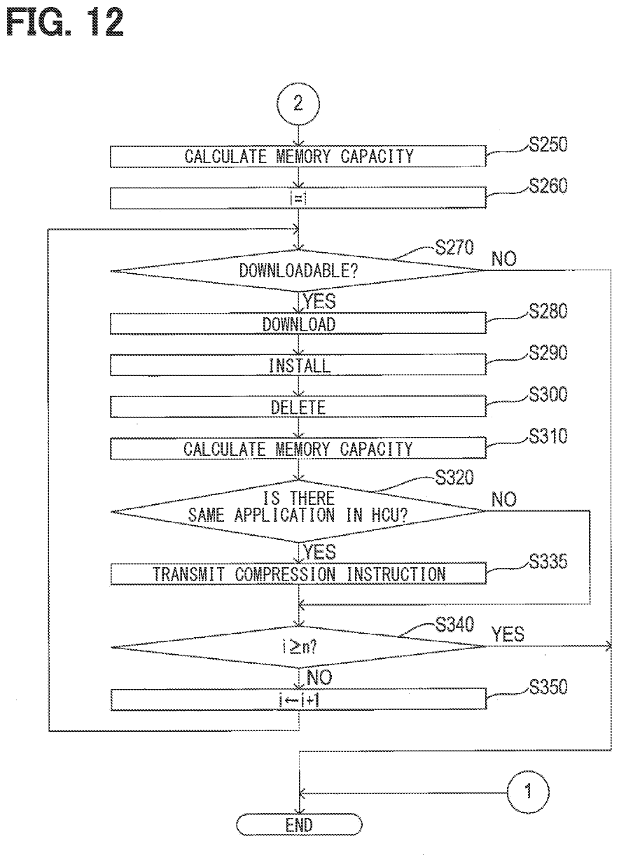

As shown in FIG. 12, the function extension processing according to the second embodiment is different from that of the first embodiment in that processing of S335 is executed instead of the processing of S330.

That is, in S320, when the function extension application program to which the same application name is set is stored in the HCU 2, in S335, the CPU 41 transmits, to the HCU 2, a compression instruction instructing compression of the function extension application program to which the same application name as the function extension application program downloaded in S280 is set, and moves the processing to S340.

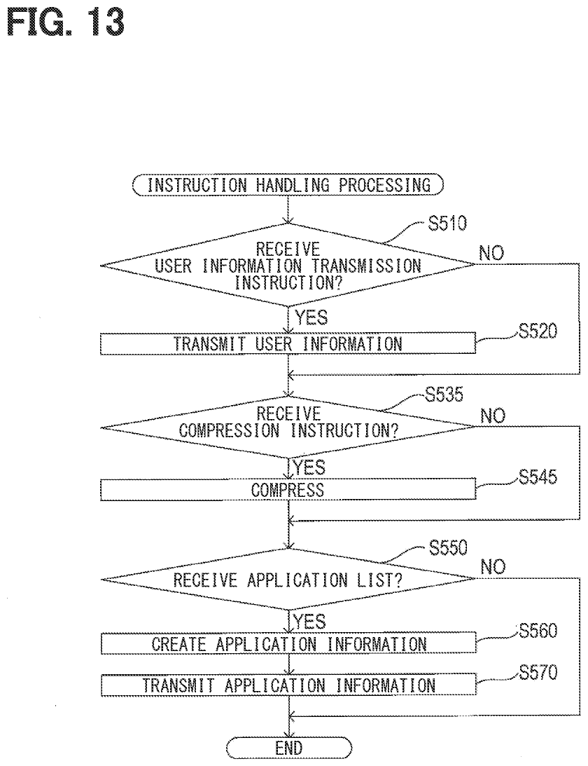

As shown in FIG. 13, the instruction handling processing according to the second embodiment is different from that of the first embodiment in that processing of S535 and S545 is executed instead of the processing of S530 and S540.

That is, when the user information transmission instruction is not received in S510, the CPU 21 moves the processing to S535. When the processing of S520 ends, the CPU 21 moves the processing to S535.

In S535, the CPU 21 determines whether the compression instruction is received from the extension module 3. Here, when the CPU 21 determines that the compression instruction is not received, the CPU 21 moves the processing to S550. On the other hand, when the compression instruction is received, the CPU 21 compresses the function extension application program specified by the compression instruction in S545, and moves the processing to S550.

In the function extension system 1 configured as described above, when the corresponding application program corresponding to the function extension application program downloaded by the extension module 3 is stored, the control unit 12 of the HCU 2 compresses the corresponding application program. Accordingly, the function extension system 1 can increase the storage capacity of the HCU 2, reduce the load on the HCU 2 itself, and facilitate the operation of the application in the HCU 2.

In the embodiment described above, S545 corresponds to processing of a compression unit.

### Third Embodiment

Hereinafter, a third embodiment according to the present disclosure will be described with reference to the drawings. In the third embodiment, portions different from those of the first embodiment will be described. The same components are denoted by the same reference numerals.

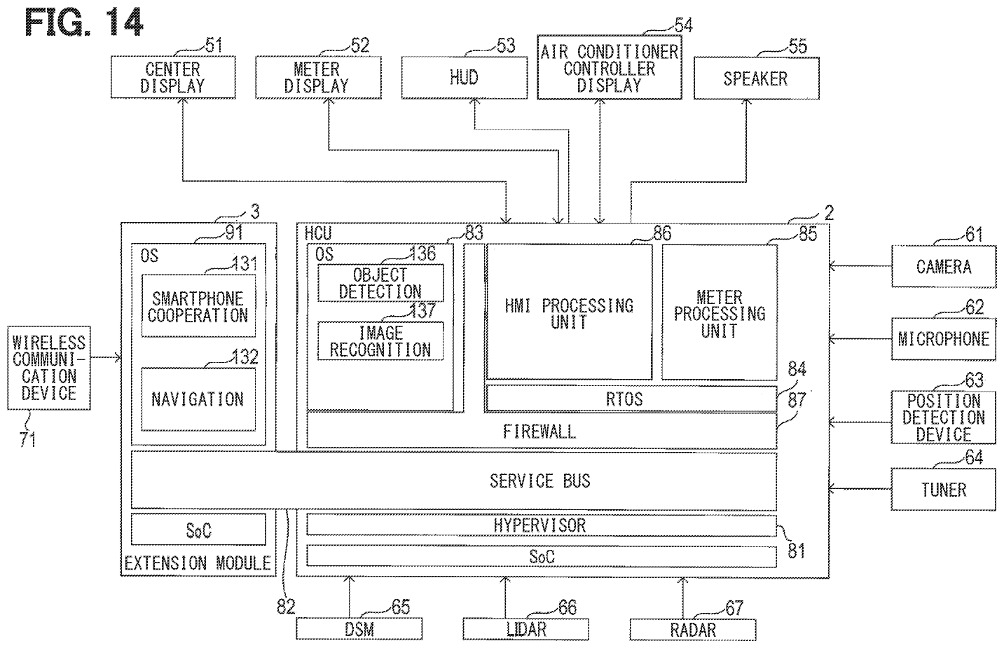

As shown in FIG. 14, the function extension system 1 according to the third embodiment is different from that of the first embodiment in that a smartphone cooperation application 131 and a navigation application 132 are installed in the OS 91. The function extension system 1 according to the third embodiment is different from that of the first embodiment in that an object detection application 136 and an image recognition application 137 are installed in the OS 83.

In the HCU 2, processing performance of the HCU is insufficient, and the applications 131, 132, 136, and 137 cannot be multiple-started. Therefore, multiple-starting is enabled by connecting the extension module 3 to the HCU 2, starting the applications 136 and 137 in the HCU 2 using the HCU of the extension module 3, and starting the applications 131 and 132 in the extension module 3. The processing performance of the SoC of the extension module 3 is not necessarily higher than the processing performance of the SoC of the HCU 2, and the extension module 3 and the HCU 2 may have processing performance of the same level. By increasing the number of SoCs, the load concentrated on one SoC is distributed, and multiple-starting of the applications 131, 132, 136, and 137 is enabled.

### Fourth Embodiment

Hereinafter, a fourth embodiment according to the present disclosure will be described with reference to the drawings. In the fourth embodiment, portions different from those of the first embodiment will be described. The same components are denoted by the same reference numerals.

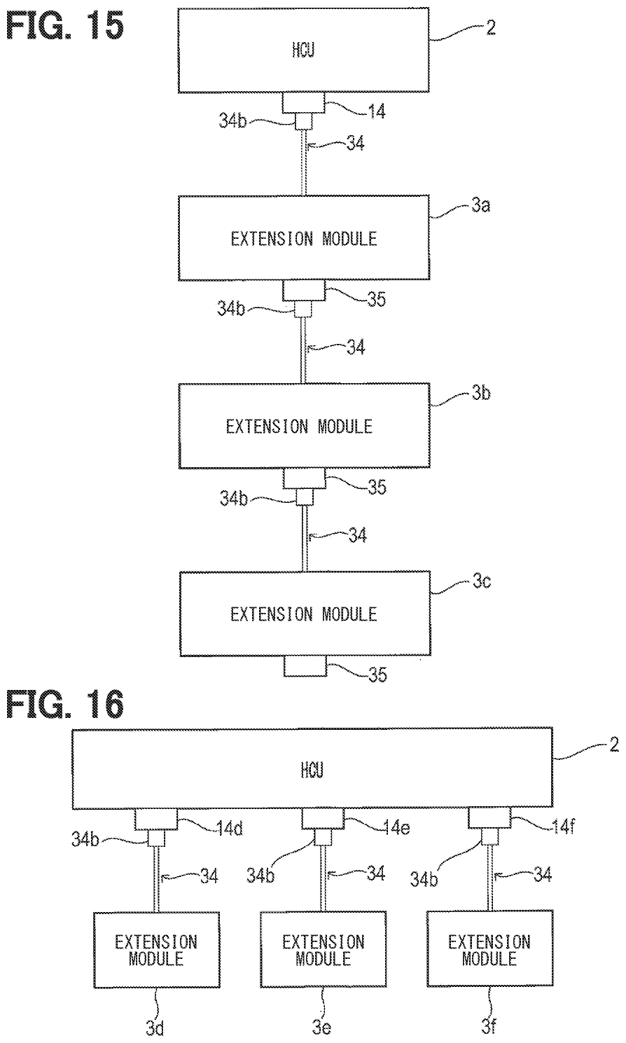

As shown in FIG. 15, the function extension system 1 according to the fourth embodiment is different from that of the first embodiment in that extension modules 3a, 3b, and 3c are provided instead of the extension module 3.

The extension modules 3a, 3b, and 3c are different from the extension module 3 according to the first embodiment in that the extension modules 3a, 3b, and 3c each include a USB connector 35. The USB connector 35 is formed so as to be attachable to and detachable from the USB connector 34b, and is connected to the USB communication unit 46.

The USB connector 34b of the extension module 3a is connected to the USB connector 14 of the HCU 2. The USB connector 34b of the extension module 3b is connected to the USB connector 35 of the extension module 3a. The USB connector 34b of the extension module 3c is connected to the USB connector 35 of the extension module 3b.

The HCU 2 receives the application information API corresponding to each of the extension modules 3a, 3b, and 3c from each of the extension modules 3a, 3b, and 3c. The HCU 2 merges the received three pieces of application information API to create one piece of new application information (hereinafter, referred to as merged application information), and transmits the merged application information to the extension modules 3a, 3b, and 3c.

In the function extension system 1 configured as described above, the HCU 2 includes the USB connector 14 that is electrically connected to one of the extension modules 3a, 3b, and 3c to perform data communication. The extension modules 3a, 3b, and 3c each include the USB connector 34b and the USB connector 35 that are electrically connected to the extension modules 3a, 3b, and 3c or the HCU 2 in order to perform data communication.

Accordingly, the function extension system 1 can connect the multiple extension modules 3a, 3b, and 3c to the HCU 2. Therefore, even when the hardware of the extension modules 3a, 3b, and 3c is lower in performance than the hardware of one extension module 3, the function extension system 1 can improve the performance of the entire vehicle control system including the HCU 2 and the extension modules 3a, 3b, and 3c.

In the embodiment described above, the USB connector 14 corresponds to a first communication connector, and the USB connectors 34b and 35 correspond to a second communication connector.

### Fifth Embodiment

Hereinafter, a fifth embodiment according to the present disclosure will be described with reference to the drawings. In the fifth embodiment, portions different from those of the first embodiment will be described. The same components are denoted by the same reference numerals.

As shown in FIG. 16, the function extension system 1 according to the fifth embodiment is different from the first embodiment in that extension modules 3d, 3e, and 3f are provided instead of the extension module 3, and the HCU 2 includes three USB connectors 14d, 14e, and 14f instead of one USB connector 14.

The extension modules 3d, 3e, and 3f have the same configuration as the extension module 3. However, among the extension modules 3d, 3e, and 3f, the extension module 3f is a latest extension module.

The USB connector 34b of the extension module 3d is connected to the USB connector 14d of the HCU 2. The USB connector 34b of the extension module 3e is connected to the USB connector 14e of the HCU 2. The USB connector 34b of the extension module 3f is connected to the USB connector 14f of the HCU 2.

The HCU 2 receives the application information API corresponding to each of the extension modules 3d, 3e, and 3f from each of the extension modules 3d, 3e, and 3f. The HCU 2 merges the received three pieces of application information API to create new merged application information, and transmits the merged application information to the extension modules 3d, 3e, and 3f.

In the function extension system 1 configured as described above, the HCU 2 includes multiple USB connectors 14d, 14e, and 14f respectively electrically connected to the extension modules 3d, 3e, and 3f in order to perform data communication.

Accordingly, the function extension system 1 can connect the multiple extension modules 3d, 3e, and 3f to the HCU 2. Therefore, even when the hardware of the extension modules 3d, 3e, and 3f is lower in performance than the hardware of one extension module 3, the function extension system 1 can improve the performance of the entire vehicle control system including the HCU 2 and the extension modules 3d, 3e, and 3f.

In the embodiment described above, the USB connectors 14d, 14e, and 14f correspond to the first communication connector.

### Sixth Embodiment

Hereinafter, a sixth embodiment according to the present disclosure will be described with reference to the drawings. In the sixth embodiment, portions different from those of the first embodiment will be described. The same components are denoted by the same reference numerals.

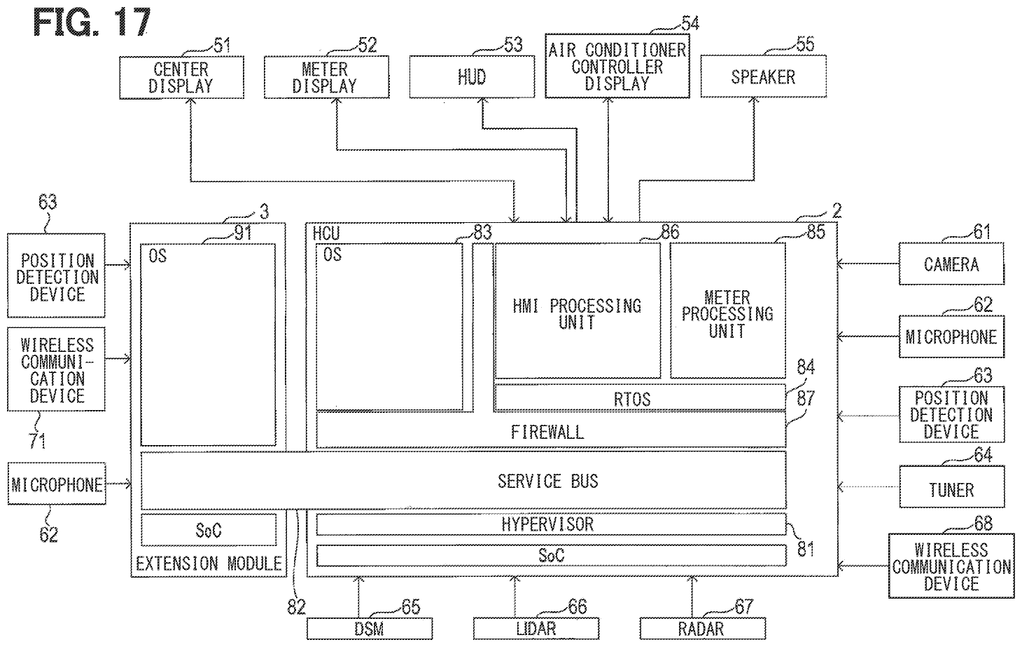

As shown in FIG. 17, the function extension system 1 according to the sixth embodiment is different from that of the first embodiment in that the position detection device 63 and the microphone 62 are also connected to the extension module 3, and a wireless communication device 68 is connected to the HCU 2. Similarly to the wireless communication device 71, the wireless communication device 68 includes a BT communication unit and a Wi-Fi communication unit.

In the function extension system 1 according to the fifth embodiment, the wireless communication device 68 is a wireless communication device whose version is older than that of the wireless communication device 71. That is, when the wireless communication device 68 is used, an operation of an application or the like is slowed down. Therefore, the function extension system 1 performs high-speed communication using the wireless communication device 71. The wireless communication device 68 is connected to the HCU 2 as a backup when the wireless communication apparatus 71 cannot be used.

For example, it is assumed that the wireless communication device 68 of an old version (for example, 4G) is connected to the HCU 2, and the wireless communication device 71 of a new version (for example, 4G) is connected to the extension module 3.

When the HCU 2 recognizes that the wireless communication device 71 on the extension module 3 side is operating, the HCU 2 turns off the Wi-Fi setting on the HCU 2 side. When the Wi-Fi used in the extension module 3 is unavailable, the Wi-Fi setting on the HCU 2 side is automatically turned on.

### Seventh Embodiment

Hereinafter, a seventh embodiment according to the present disclosure will be described with reference to the drawings. In the seventh embodiment, portions different from those of the first embodiment will be described. The same components are denoted by the same reference numerals.

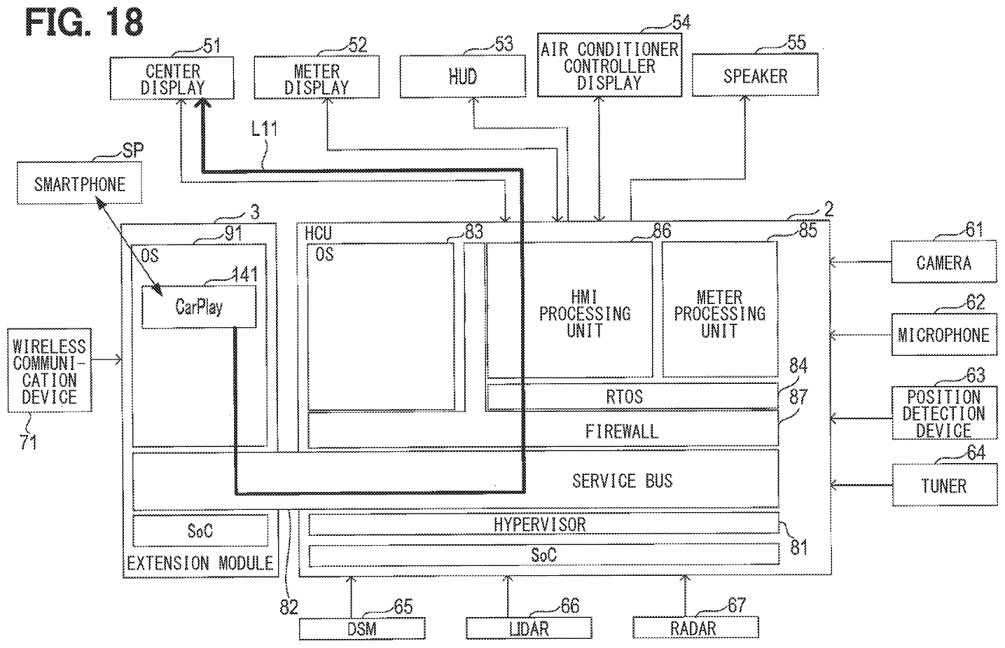

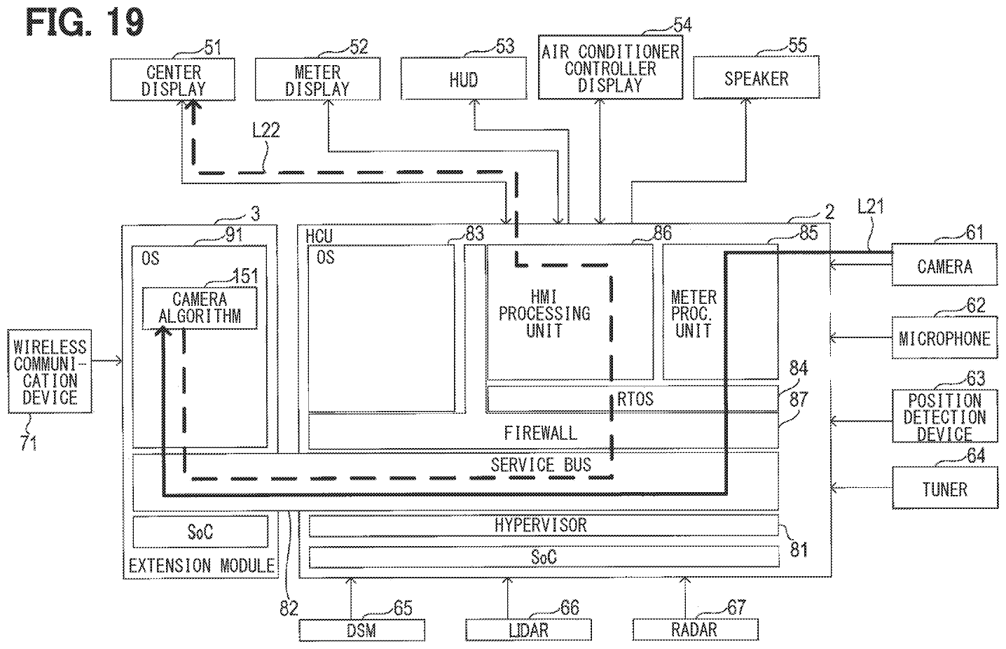

As shown in FIG. 18, the function extension system 1 according to the seventh embodiment is different from that of the first embodiment in that a CarPlay 141 is mounted on the OS 91. The CarPlay is a registered trademark.

The CarPlay 141 performs data communication with a smartphone SP, acquires screen data indicating a smartphone screen displayed on the smartphone SP, and transmits the screen data to the HCU 2. The HMI processing unit 86 outputs the received screen data to the center display 51. A polygonal line L11 shown by a solid line in FIG. 18 indicates a path of data from the CarPlay 141 to the center display 51.

The HMI processing unit 86 transmits, to the CarPlay 141, screen touch data or the like input by the user on the center display 51.

In a case of smartphone cooperation including Android Auto, an operation is performed in a similar manner as that of the CarPlay. The ANDROID is a registered trademark.

### Eighth Embodiment

Hereinafter, an eighth embodiment according to the present disclosure will be described with reference to the drawings. In the eighth embodiment, portions different from those of the first embodiment will be described. The same components are denoted by the same reference numerals.

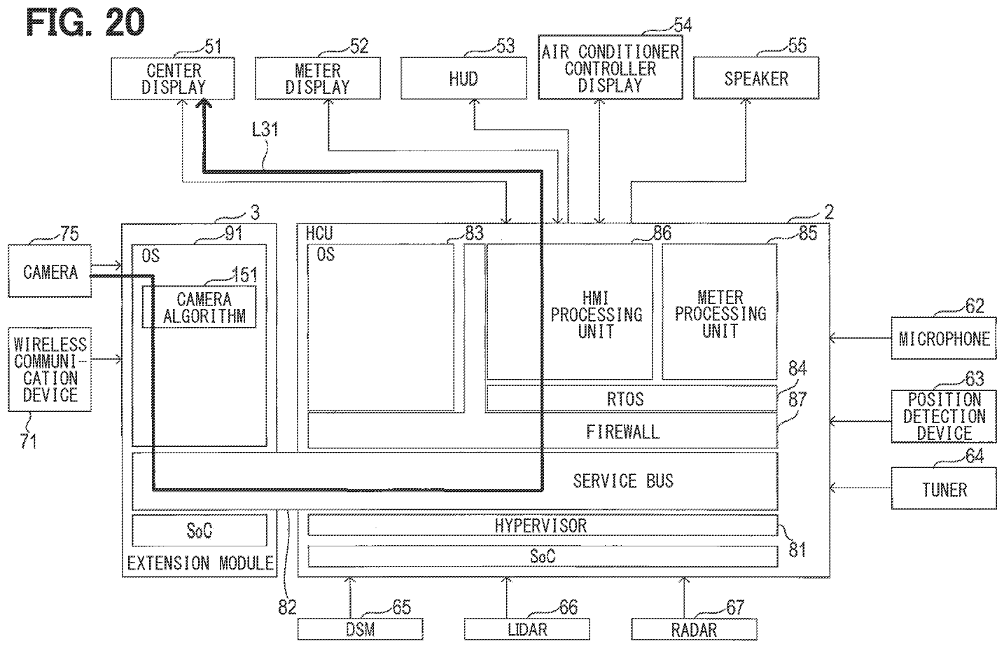

As shown in FIG. 19, the function extension system 1 according to the eighth embodiment is different from that of the first embodiment in that a camera algorithm 151 is installed in the OS 91. The camera algorithm 151 is an application that performs image analysis and the like using the acquired camera image data.

Since the specification of the HCU 2 is insufficient, the HCU 2 cannot operate the camera algorithm 151. The extension module 3 can operate the camera algorithm 151 since the extension module 3 has a SoC newer than that of the HCU 2 and has a higher specification.

The camera algorithm 151 receives the camera image data obtained by imaging of the camera 61. A polygonal line L21 shown by a solid line in FIG. 19 indicates a path of data to the camera algorithm 151.

The camera algorithm 151 performs the image analysis using the camera image data acquired from the camera 61, and transmits analysis data indicating an analysis result to the HCU 2. The HMI processing unit 86 outputs the received analysis data to the center display 51. A polygonal line L22 shown by a dashed line in FIG. 19 indicates a path of data from the camera algorithm 151 to the center display 51.

An algorithm for analyzing devices connected to the HCU 2 similarly to the camera system described above, such as the LIDAR 66 and the radar 67, is installed in the OS 91 similarly to the camera algorithm 151. The algorithm performs analysis using data acquired by the LIDAR 66, the radar 67, and the like, and transmits the analysis data to the HCU 2.

### Ninth Embodiment

Hereinafter, a ninth embodiment according to the present disclosure will be described with reference to the drawings. In the ninth embodiment, portions different from those of the first embodiment will be described. The same components are denoted by the same reference numerals.

As shown in FIG. 20, the function extension system 1 according to the ninth embodiment is different from that of the first embodiment in that the camera algorithm 151 is installed in the OS 91, the camera 61 is omitted, and a camera 75 having higher performance than the camera 61 is connected to the extension module 3.

Since the specification of the HCU 2 is insufficient, the HCU 2 cannot operate the camera algorithm 151. The extension module 3 can operate the camera algorithm 151 since the extension module 3 has a SoC newer than that of the HCU 2 and has a higher specification.

Camera image data obtained by imaging of the camera 75 is input to the camera algorithm 151. The camera algorithm 151 performs image analysis using the camera image data acquired from the camera 75, and transmits analysis data indicating an analysis result to the HCU 2. The HMI processing unit 86 outputs the received analysis data to the center display 51. A polygonal line L31 shown by a solid line in FIG. 20 indicates a path of data from the camera 75 to the center display 51.

An algorithm for analyzing the LIDAR, the radar, and the like is mounted in the OS 91 similarly to the camera system described above. The LIDAR, the radar, and the like are connected to the extension module 3. The algorithm performs analysis using data acquired by the LIDAR, the radar, and the like, and transmits the analysis data to the HCU 2.

Although embodiments of the present disclosure have been described above, the present disclosure is not limited to the above embodiments, and various modifications can be made to implement the present disclosure.

[First Modification]

For example, in the first embodiment, the USB communication is performed between the HCU 2 and the extension module 3. However, the present disclosure is not limited to the USB communication, and the communication may be performed by, for example, PCI-Ex. The HCU 2 and the extension module 3 may be connected to each other by performing wireless communication between the HCU 2 and the extension module 3.

[Second Modification]

In the first embodiment, the HCU 2 transmits the user information, whereas the HCU 2 may specify a user using a personal authentication result by a DSM and transmit the user information indicating the specified user to the server 4.

[Third Modification]

In the fourth and fifth embodiments, the HCU 2 merges the application information API of the multiple extension modules 3. However, the HCU 2 may merge the application information API of one of the multiple extension modules 3.

[Fourth Modification]

In the first embodiment, the rearrangement condition information is stored in the extension module 3, whereas the rearrangement condition information may be stored in the HCU 2. When the rearrangement condition information is stored in the HCU 2, the HCU 2 transmits the rearrangement condition information to the extension module 3. The rearrangement condition information may be stored in both the HCU 2 and the extension module 3. In this case, it is necessary for a manufacturer of the HCU 2 or the extension module 3 to specify in advance whether to use the rearrangement condition information of the HCU 2 or the rearrangement condition information of the extension module 3.

[Fifth Modification]

An application that is not installed in the HCU 2 can also be downloaded to the extension module 3 and operated in a similar manner as that of the application installed in the HCU 2. In this case, for example, the use frequency is set to 0, and the priority is set to 0.

The control units 12, 32, and 202 and methods thereof described in the present disclosure may be implemented by a dedicated computer including a processor and memory programmed to perform one or more functions embodied by a computer program. Alternatively, the control units 12, 32, and 202 and the method thereof described in the present disclosure may be implemented by a dedicated computer including a processor implemented by one or more dedicated hardware logic circuits. Alternatively, the control units 12, 32, and 202 and the methods thereof described in the present disclosure may be implemented by one or more dedicated computers implemented by a combination of a processor and memory programmed to execute one or more functions, and a processor implemented by one or more hardware logic circuits. The computer program may also be stored on a computer readable non-transitory tangible recording medium as computer executable instructions. The methods of implementing the functions of the units provided in the control units 12, 32, and 202 do not necessarily need to include software, and all of the functions may be implemented with the use of one or multiple hardware.

Multiple functions belonging to one configuration element in the above-described embodiment may be implemented by multiple configuration elements, or one function belonging to one configuration element may be implemented by multiple configuration elements. Multiple functions belonging to multiple configuration elements may be implemented by one configuration element, or one function implemented by multiple configuration elements may be implemented by one configuration element. A part of the configuration of the above embodiment may be omitted. At least a part of the configuration of the above embodiment may be added to or substituted by the configuration of another embodiment.

In addition to the above-described function extension system 1, the present disclosure may be implemented in various forms such as a program for causing a computer to function as the function extension system 1, a medium in which the program is recorded, and a function extension method.

1. A function extension system, comprising:
a first electronic control device mounted in a vehicle;
at least one second electronic control device mounted in the vehicle; and
a server disposed outside of the vehicle and configured to perform data communication with both the first electronic control device and the at least one second electronic control device, wherein
the first electronic control device includes:
a first control unit configured to execute a first operating system for operating at least one first application that controls a device mounted in the vehicle;
a first device communication unit configured to perform data communication with the at least one second electronic control device;
a first server communication unit configured to perform data communication with the server;
a housing configured to house the first control unit, the first device communication unit, and the first server communication unit therein; and
a user information transmission unit configured to transmit user information for identifying a user of the vehicle to the server when the data communication with the second electronic control device is established by the first device communication unit,
the at least one second electronic control device includes:
a second control unit configured to execute a second operating system for operating at least one second application that controls a device mounted in the vehicle;
a second device communication unit configured to perform data communication with the first electronic control device;
a second server communication unit configured to perform data communication with the server;
a specification information transmission unit configured to transmit specification information indicative of a specification of the at least one second electronic control device to the server; and
a download unit configured to, when receiving an application list including at least one piece of application specifying information for specifying an application available to the at least one second electronic control device, download an application program specified by the application specifying information from the server, and
the server includes
a creation unit configured to:
create the application list based on the user information and the specification information when receiving the user information and the specification information; and
transmit the created application list.

2. The function extension system according to claim 1, wherein
the at least one piece of the application specifying information is a plurality of pieces of the application specifying information each of which specifies the application program, and
determination information for determining a download order of the application program is added to each of the plurality of pieces of the application specifying information in the application list.

3. The function extension system according to claim 2, wherein
the application list includes, as the determination information, information related to a use frequency of the application corresponding to each of the plurality of pieces of the application specifying information.

4. The function extension system according to claim 2, wherein
the application list includes, as the determination information, information related to a category of the application corresponding to each of the plurality of pieces of the application specifying information.

5. The function extension system according to claim 2, wherein
the application list includes, as the determination information, information related to a priority of the application corresponding to each of the plurality of pieces of the application specifying information.

6. The function extension system according to claim 2, wherein
the application list includes, as the determination information, information related to a start order of the application corresponding to each of the plurality of pieces of the application specifying information.

7. The function extension system according to claim 2, wherein
the application list includes, as the determination information, information related to a memory capacity used by the application corresponding to each of the plurality of pieces of the application specifying information.

8. The function extension system according to claim 2, wherein
the first electronic control device includes
a deletion unit configured to delete a corresponding application program stored in the first electronic control device if the corresponding application program corresponds to the application program downloaded by the at least one second electronic control device.

9. The function extension system according to claim 2, wherein
the first electronic control device includes
a compression unit configured to compress a corresponding application program that is stored in the first electronic control device if the corresponding application program corresponds to the application program downloaded by the at least one second electronic control device.

10. The function extension system according to claim 1, wherein
the at least one second electronic control device is a plurality of second electronic control devices,
the first electronic control device includes a first communication connector that is electrically connected to one of the plurality of second electronic control devices to perform data communication therebetween, and
each of the plurality of second electronic control devices includes at least two second communication connectors that are electrically connected to another one of the plurality of second electronic control devices or the first electronic control device to perform data communication therebetween.

11. The function extension system according to claim 1, wherein
the at least one second electronic control device is a plurality of second electronic control devices, and
the first electronic control device includes a plurality of first communication connectors each of which is electrically connected to a respective one of the plurality of second control devices to perform data communication.

12. An electronic control device connected to an in-vehicle electronic control device mounted in a vehicle to perform data communication with the in-vehicle electronic control device, the electronic control device comprising:
a control unit configured to execute an operating system for operating at least one application that controls a device mounted in the vehicle;
a device communication unit configured to perform data communication with the in-vehicle electronic control device;
a server communication unit configured to perform data communication with a server disposed outside of the vehicle;
a specification information transmission unit configured to transmit specification information indicative of a specification of the electronic control device to the server; and
a download unit configured to, when receiving an application list including at least one piece of application specifying information for specifying an application available to the electronic control device, download an application program specified by the application specifying information from the server.
